(19) United States
(12) Patent Application Publication
(10) Pub. No.: US 2013/0249139 A1
(43) Pub. Date: Sep. 26, 2013

(54) METHOD FOR MANUFACTURING TUBULAR BODY

(71) Applicant: FUJI XEROX CO., LTD., Tokyo (JP)

(72) Inventors: Shoichi MORITA, Kanagawa (JP); Kenji OMORI, Kanagawa (JP); Tomoo MATSUSHIMA, Kanagawa (JP)

(73) Assignee: FUJI XEROX CO., LTD., Tokyo (JP)

(21) Appl. No.: 13/737,490

(22) Filed: Jan. 9, 2013

(30) Foreign Application Priority Data
Mar. 23, 2012 (JP) 2012-068292

(51) Int. Cl. B29D 23/00

(52) U.S. Cl. CPC B29D 23/001
USPC 264/209.2

(57) ABSTRACT

Provided is a tubular body manufacturing method including preparing a resin composition containing a crystalline thermoplastic resin and molding the tubular body, using an extrusion molding machine that includes a cylindrical portion and a transport member which has a shaft member and a protrusion and is divided into a supply portion, a compressing portion and a measuring portion, by melting, kneading and transporting the resin composition through heating of the heat source and rotation of the transport member, and then extruding the molten resin composition, in which, when ΔTm (° C.) is a difference between a crystalline melt finish temperature and a crystalline melt start temperature of the crystalline thermoplastic resin, D (mm) is a diameter of the transport member, and Lc (mm) is a length of the compressing portion of the transport member, a relationship of following Expression (1) is satisfied:

(ΔTm/10)−3<Lc/D<(ΔTm/10)+1. Expression (1):

### CROSS-REFERENCE TO RELATED APPLICATIONS

This application is based on and claims priority under 35 USC 119 from Japanese Patent Application No. 2012-068292 filed Mar. 23, 2012.

### BACKGROUND

### Technical Field

The present invention relates to a method for manufacturing a tubular body.

### SUMMARY

According to an aspect of the invention, there is provided a method for manufacturing a tubular body including preparing a resin composition containing a crystalline thermoplastic resin; and molding the tubular body, using an extrusion molding machine that includes a cylindrical portion having a heat source and a transport member which is inserted into the inside of the cylindrical portion and has a shaft member and a protrusion which is provided in a helical-shape on an outer circumference surface of the shaft member and is divided into a supply portion, a compressing portion and a measuring portion, by melting, kneading and transporting the resin composition in the inside of the cylindrical portion from one end toward the other end thereof through heating of the heat source and rotation of the transport member, and then extruding the molten resin composition, in which, when ΔTm (° C.) is a difference between a crystalline melt finish temperature and a crystalline melt start temperature of the crystalline thermoplastic resin measured by a differential scanning calorimeter, D (mm) is a diameter of the transport member, and Lc (mm) is a length of the compressing portion of the transport member, a relationship represented by following Expression (1) is satisfied:

(ΔTm/10)−3<Lc/D<(ΔTm/10)+1. Expression (1):

### BRIEF DESCRIPTION OF THE DRAWINGS

Exemplary embodiments of the present invention will be described in detail based on the following figures, wherein:

FIG. 1 is a schematic view showing a periphery of a resin melt-transport portion of an extrusion molding machine that is used for a tubular body manufacturing method according to an exemplary embodiment;

FIG. 2 is a schematic perspective view showing a tubular unit of the extrusion molding machine according to the exemplary embodiment that is used for the tubular body manufacturing method according to the exemplary embodiment;

FIG. 3 is a schematic side view showing a screw of the extrusion molding machine that is used for the tubular body manufacturing method according to the exemplary embodiment; and

FIG. 4 is a schematic graph showing an example of a DSC curve that is obtained from a differential scanning calorimeter.

### DETAILED DESCRIPTION

Hereafter, an exemplary embodiment that is an example of the aspect of the invention will be described.

In a tubular body manufacturing method according to an exemplary embodiment, first, a resin composition containing a crystalline thermoplastic resin is prepared.

Specifically, for example, a particulate resin composition (hereinafter, referred to as “resin pellets”) is obtained by melting and kneading the crystalline thermoplastic resin and, if required, other additives by using a single-axial melt kneader or a double-axial melt kneader.

Next, a tubular body is molded by extruding the resin pellets (which is a resin composition) using an extrusion molding machine 10.

The extrusion molding machine 10 will be described.

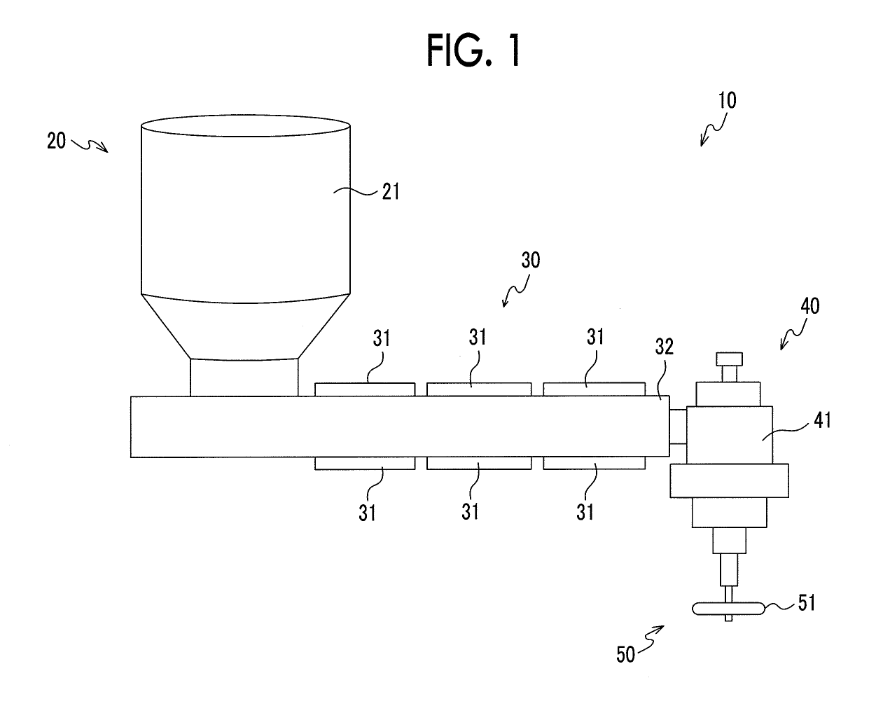

For example, the extrusion molding machine 10 includes a resin supply portion 20, a resin melt-transport portion 30, a tubular-shape molding portion 40, and a cooling portion 50, as shown in FIG. 1.

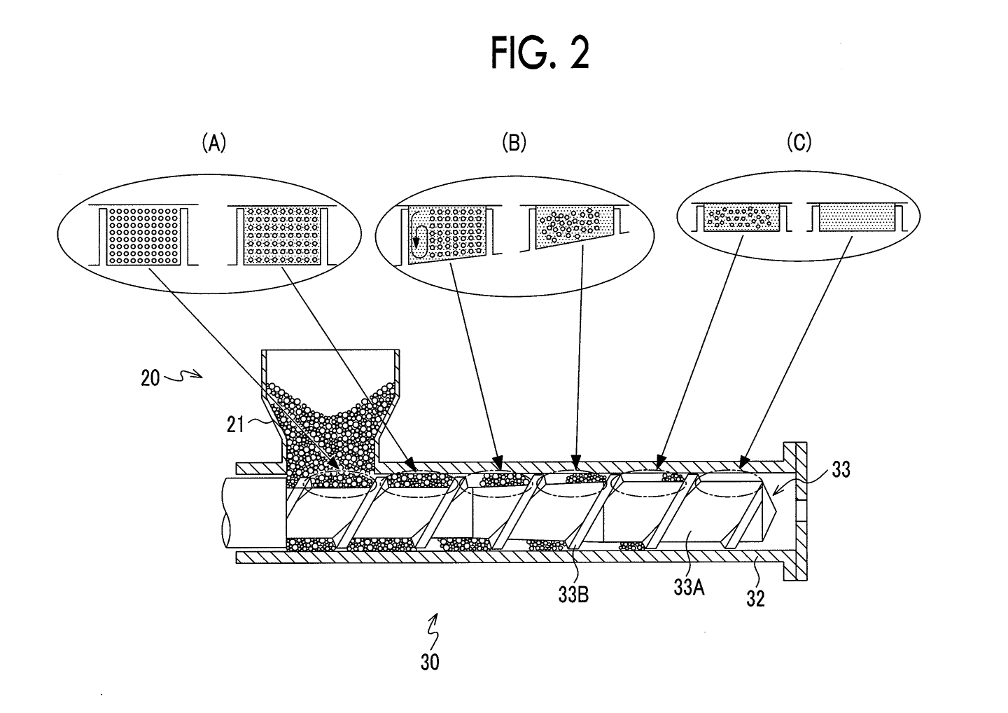

For example, the resin melt-transport portion 30 includes a cylindrical portion 32 (hereinafter, referred to as a “barrel 32”) which has a heat source 31 in an outer circumferential surface side and a transport member 33 (hereinafter, referred to as a “screw 33”) which is inserted into the barrel 32, as shown in FIGS. 1 and 2. In addition, a circulation pipe of high temperature medium, a heater, or the like is included as the heat source 31.

For example, the resin supply portion 20 includes a cylindrical member 21 (hereinafter, referred to as a “hopper 21”) which is connected to one end of the barrel 32.

For example, the tubular-shape molding portion 40 includes an extrusion nozzle for molding 41 (hereinafter, referred to as an “extrusion die 41”) which is connected to the other end of the barrel 32.

For example, the cooling portion 50 includes a cooling source 51. In addition, a sizing die or the like is included as the cooling source 51.

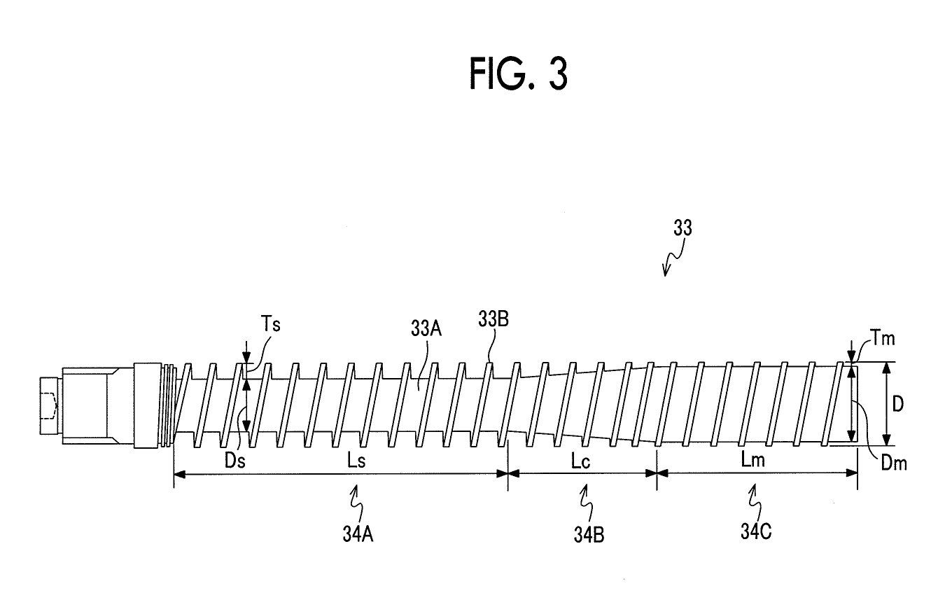

For example, the screw 33 is a full-flight type screw as shown in FIG. 3 and is configured of a shaft member 33A and a protrusion 33B which is provided in a helical-shape on an outer circumference surface of the shaft member 33A.

Additionally, as a type of screw 33, a full-flight screw in which one of protrusions 33B is basically disposed in a helical-shape by the same pitch, is suitable due to its versatility having appropriate plasticizing capacity which does not require applications of excessive heat energy and shear energy to a resin composition. However, the type of screw is not limited thereto, and various shapes of screws may be used, such as a maillefer type or a spiral maddock type screw.

In the screw 33, a diameter D (which is the maximum diameter) including the protrusion 33B which protrudes from the shaft member 33A does not vary in a longitudinal direction. In order to make the screw 33 easily inserted into the barrel 32, the diameter of an insert-side tip end of the screw 33 may be designed smaller than that of the other end thereof (for example, when designed smaller in the range from 0.05 mm to 0.2 mm), but the difference is slight, thus assuming that there is practically no variation.

For example, the screw 33 is divided into a supply portion 34A, a compressing portion 34B and a measuring portion 34C in a sequence from one end in a resin composition supply side toward the other end thereof.

In the one end portion in a resin composition supply side, the supply portion 34A is a region in which the diameter of the shaft member 33A is smaller than that in an extrusion side and does not vary. That is, in the one end portion in a resin composition supply side, the supply portion 34A is the region in which the height of the protrusion 33B from the outer circumstance surface of the shaft member 33A is larger than that in the extrusion side and does not vary.

The compressing portion 34B is a region in which the diameter of the shaft member 33A becomes increased incrementally or gradually from the resin composition supply side toward the extrusion side. That is, the compressing portion 34B is the region in which the height of the protrusion 33B from the outer circumstance surface of the shaft member 33A becomes decreased incrementally or gradually from the resin composition supply side toward the extrusion side.

In the other end portion in the resin composition extrusion side, the measuring portion 34C is a region in which the diameter of the shaft member 33A is larger than that in the supply side and does not vary. That is, in the one end portion in the resin composition supply side, the supply portion 34A is the region in which the height of the protrusion 33B from the outer circumstance surface of the shaft member 33A is smaller than that in the supply side and does not vary.

The molding of the resin composition by the extrusion molding machine 10 will be described.

In the extrusion molding machine 10, when resin pellets are inputted from the hopper 21 into one end of the barrel 32, the resin composition is melted, kneaded and transported through heating of the heat source 31 and rotation of the screw 33 in the barrel 32 from one end thereof toward the other end thereof. Subsequently, the melt-kneaded resin composition is extruded from the other end of the barrel 32 to the extrusion die 41 so as to be molded in a tubular shape.

Specifically, first, in the supply portion 34A of the screw 33, the resin pellets inputted from the hopper 21 is transported by torque of the screw 33 while raising the temperature of the resin pellets through heat transfer from the barrel 32 which is heated by the heat source 31 (see FIG. 2(A)).

Next, in the compressing portion 34B of the screw 33, the melting process of the resin pellets starts through the heat transfer from the barrel 32 which is heated by the heat source 31 and the shearing force due to the rotation of the screw 33 so as to provide a semi-molten resin composition. Also, the semi-molten resin composition is transported to the measuring portion 34C through the thrust force of the resin pellets which is pushed out from the supply portion 34A and the thrust force of the semi-molten resin composition which is generated at a groove (which is a screw groove) formed between the protrusions 33B of the screw 33 (see FIG. 2(B)).

Subsequently, in the measuring portion 34C of the screw 33, the semi-molten resin composition is completely melted through the heat transfer from the barrel 32 which is heated by the heat source 31. Also, the molten resin composition is plasticized through the shearing force caused by the rotation of the screw 33 and pressure caused by pressing from the compressing portion 34B, to thereby form a state in which a suitable fluidity is secured in the extrusion die 41 (see FIG. 2(C)).

Next, the molten resin composition which is pushed out from the barrel 32 (the measuring portion 34C of the screw 33) is melt-extruded in a tubular shape through the extrusion die 41 and received while being stretched. After that, an inner circumference surface and an outer circumference surface of the resin composition which are extruded in a tubular shape are cooled by the cooling source 51.

Especially, in a case where the inner circumference and the outer circumference surface of the resin composition which are extruded in a tubular shape are cooled and stretched simultaneously, evenness of crystallization is secured. Also, it is considered that the obtained tubular body is under a tense state due to the extension of a molecular chain which is caused by arranging the resin molecules through stretching. Thereby, smoothness of the surface is secured and surface strength is improved properly.

Thereafter, the obtained tubular body is, for example, cut by an intended width.

Through the above-mentioned processes, a tubular body including a resin composition is manufactured.

In the above-described method for manufacturing a tubular body according to the exemplary embodiment, a tubular body is manufactured through a process in which a resin composition containing a crystalline thermoplastic resin is prepared and a process in which, in a barrel 32 from one end toward the other end, the resin composition is firstly melted, kneaded and transported through heating of the heat source 31 and rotation of the screw 33, after that, the molten resin composition is extruded so as to mold a tubular body by using the extrusion molding machine in which the barrel 32 (the cylindrical portion) having the heat source 31 and the screw 33 (the transport member) inserted into the cylindrical portion are provided.

In this case, since a melting behavior of the crystalline thermoplastic resin differs during heating due to the structure thereof, a selection range of the condition for proper extrusion molding is limited, and, if the condition is not satisfied, there is a tendency for the film thickness of the molded tubular body to be uneven when the tubular body is molded from the resin composition containing a crystalline thermoplastic resin by using the extrusion molding method for manufacturing continuously under a fixed processing condition.

Therefore, in the tubular body manufacturing method according to the exemplary embodiment, melting of the crystalline thermoplastic resin in which the melting behavior differs is surely started in the compressing portion 34B of the screw 33 and the melt-started crystalline thermoplastic resin is transported to the measuring portion 34C of the screw 33 by satisfying a relationship represented by following Expression (1) (preferably, a relationship represented by following Expression (1-2)).

As a result, in the tubular body manufacturing method according to the exemplary embodiment, variation of the extrusion amounts of the molten resin composition is suppressed, whereby generation of unevenness of the film thickness is suppressed in the molded tubular body.

(ΔTm/10)−3<Lc/D<(ΔTm/10)+1 Expression (1):

(ΔTm/10)−2<Lc/D<(ΔTm/10) Expression (1-2):

In Expressions (1) and (1-2), ΔTm indicates a difference (° C.) between the crystalline melt finish temperature and the crystalline melt start temperature of the crystalline thermoplastic resin which is measured by a differential scanning calorimeter.

D indicates the diameter (mm) of the screw 33 (the transport member).

Lc indicates the length (mm) of the compressing portion 34B of the screw 33 (the transport member).

To describe details more, the following theory with regard to the melting and the plasticization of the resin pellets by the screw 33 in the barrel 32 is known.

The resin pellets, which are supplied from the hopper 21 and are deposited in the grooves (hereinafter, referred to as the “screw groove”) formed between the protrusion 33B of the screw 33, are sent forward (which is the extrusion die side) by the impulsive force due to the rotation of the screw 33 while being heated to near the melting point thereof by the heat transfer from the barrel 32 which is heated by the heat source 31 in the supply portion 34A of the screw 33. Thereby, the melting process of the resin pellets is started (see FIG. 2(A)).

Next, most of the resin pellets which are further heated in the compressing portion 34B of the screw 33 start melting. At this time, since the depth of the screw groove (which is the height of the protrusion 33B) gradually decreases toward the front of the screw 33, the melt-started resin pellets are moved forward through sliding which is caused by the shearing force between the screw 33 and the barrel 32 in the screw groove. Then the resin pellets and the molten resin are mixed and moved forward by the added thrust force of the resin pellets from the rear (which is the resin composition supply side). As the mixture of the resin pellets and the molten resin moves forward and as the screw groove slides forward to the screw 33, the mixture is compressed due to the depth of the screw groove gradually decreasing, and additionally, the mixture is completely melted due to the added shearing force and then is transported to the measuring portion 34C of the screw 33 (see FIG. 2(B)).

Moreover, in the measuring portion 34C of the screw 33, the cross-section of the screw is smaller than that of the screw groove of the supply portion 34A (for example, which is approximately ⅓), and the reciprocal number of the cross-section ratio is designated as a compression ratio which is a design factor of the screw 33 as well.

The melting process of the resin pellets in the compressing portion 34B of the screw 33 is progressed through the heat transfer from the barrel 32 which is heated by the heat source 31 and the shear heating which is applied to the resin pellets softened by raised temperature through the shearing force which is generated between the screw 33 rotating and the barrel 32.

In a case where the melting process of the resin pellets is started in the rearward (that is, the supply portion 34A) of the compressing portion 343 in which the depth of the screw groove (which is the height of the protrusion 33B) is gradually decreased, the thrust force which is applied to the molten resin because of the depth of the screw groove (which is the height of the protrusion 33B) being gradually decreased toward the forward of the screw 33 is not generated. Thereby, it is likely that the thrust force of the resin pellets sent from the supply portion 34A is only applied so that it is difficult to obtain enough thrust force to move semi-molten resin lumps forward. Subsequently, the resin pellets in a semi-molten state does not move while being deposited in the screw grooves. Therefore, there is a tendency that a rotate load of the screw 33 is increased, whereby a rotation stop (hereinafter, referred to as an “over-torque”) easily occurs.

Likewise, in a case that the melting process of the resin pellets is finished in the forward (which is the measuring portion 34C) of the compressing portion 34B in which the depth of the screw groove (which is the height of the protrusion 33B) is gradually decreased, it is hard for the resin pellets in a semi-molten state to be advanced to the measuring portion 34C in which the depth of the screw groove is shallow. Thereby, the resin pellets may be hardly moved and be deposited. Therefore, there is a tendency that the over-torque is generated as well.

Accordingly, the melt start position and the melt finish position of the resin pellets should be in the compressing portion 34B of the screw 33.

In this case, although the crystalline melt start temperature and the crystalline melt finish temperature of a crystalline thermoplastic resin take various values depending on a crystal structure thereof and a molecular weight distribution, a rising peak temperature of the melting endothermic heat when the temperature is increased measured by the differential scanning calorimeter (DSC) corresponds to the crystalline melt start temperature and a decreasing peak temperature corresponds to the crystalline melt finish temperature. Generally, a crystalline thermoplastic resin having simple composition and narrow molecular weight distribution has a small difference between the crystalline melt start temperature and the crystalline melt finish temperature, and a crystalline thermoplastic resin which has the composition in which a different structure or wide molecular weight distribution is included has a large difference between the temperatures.

Therefore, it is necessary that the melting process of the crystalline thermoplastic resin be carried out in a proper position by controlling the temperature of barrel 32 through the heat source 31 and the rotation rate of the screw 33 such that the melt start position and the melt finish position of the crystalline thermoplastic resin are in the compressing portion 34B of the screw 33.

At this time, the screw 33 of which the compressing portion 34B is relatively long is suitable to be used for the crystalline thermoplastic resin having a large difference between the crystalline melt start temperature and the crystalline melt finish temperature, whereas the screw 33 of which the compressing portion 34B is relatively short is suitable to be used for the crystalline thermoplastic resin having a small difference between the temperatures.

Moreover, in a case where the screw 33 of which the compressing portion 34B is relatively long is adopted to be used for the crystalline thermoplastic resin having a small difference between the temperatures, and decreasing amounts of the depth of the screw groove (which is the height of the protrusion 33B) toward the forward of the screw 33 are small as well. Thereby, the thrust force to convey the molten resin which is rapidly melted in the entrance side of the compressing portion 34B in a narrow range thereof is not enough such that there is a tendency that transport amounts of the molten resin fluctuate.

Therefore, selecting the screw 33 of which the length of the compressing portion 34B corresponds to the amount of the difference between the crystalline melt start temperature and the crystalline melt finish temperature of the crystalline thermoplastic resin is preferable in order to stabilize the melting operation and the transport operation of the crystalline thermoplastic resin, whereby transport amounts of the molten resin are maintained.

That is, in the tubular body manufacturing method according to the exemplary embodiment, satisfying above Expression (1) means selecting the screw 33 of which the length of the compressing portion 34B corresponds to the amount of the difference between the crystalline melt start temperature and the crystalline melt finish temperature of the crystalline thermoplastic resin. Also, by satisfying above Expression (1), variation of the extrusion amount of the molten resin composition is suppressed, whereby generation of unevenness of the film thickness is suppressed in the molded tubular body.

Also, generation of an over torque is avoided. Additionally, since it is possible to continuously obtain the tubular body of which unevenness of the film thickness is suppressed through extrusion molding, whereby cost reduction is achieved due to the improved productivity as well.

Further, in the tubular body which is obtained by the tubular body manufacturing method according to the exemplary embodiment, since the unevenness of the film thickness thereof is suppressed, images having suppressed color deviation are obtained in the electrophotographic image forming apparatus which adopts the tubular body as an intermediate transfer belt.

Suitable characteristics of the screw 33 (the transport member) will be described.

The diameter D (mm) of the screw 33 may be within the range from 25 mm to 60 mm (preferably, from 30 mm to 50 mm and more preferably, from 30 mm to 45 mm).

The diameter D (mm) of the screw 33 indicates the maximum diameter including the protrusion 33B which protrudes from the shaft member 33A.

However, as described above, although there is a case that the diameter of the insert-side tip end of the screw 33 may be designed so as to be smaller than that of the other end thereof (for example, when designed smaller in the range of from 0.05 mm to 0.2 mm) in order to make the screw 33 easily inserted into the barrel 32, the average diameter of the insert-side tip end and the other end is set as the diameter D of the screw 33 at this time.

The length Lc (mm) of the compressing portion 34B of the screw 33 may be within the range from 50 mm to 540 mm (preferably, from 60 mm to 240 mm).

The length Ls (mm) of the supply portion 34A of the screw 33 may be within the range from 200 mm to 900 mm (preferably, from 250 mm to 780 mm).

The diameter Ds of the shaft member 33A in the supply portion 34A of the screw 33 may be within the range from 18 mm to 30 mm.

The height Ts of the protrusion 33B in the supply portion 34A of the screw 33 may be within the range from 3.2 mm to 10 mm.

The length Lm (mm) of the measuring portion 34C of the screw 33 may be within the range from 150 mm to 720 mm (preferably, from 200 mm to 600 mm).

The diameter Dm of the shaft member 33A in the measuring portion 34C of the screw 33 may be within the range from 32 mm to 37 mm.

The height Tm of the protrusion 33B in the measuring portion 34C of the screw 33 may be within the range from 1.5 mm to 3.8 mm.

The resin composition will be described.

The resin composition is composed by containing a crystalline thermoplastic resin and, if required, other additives. The resin composition contains a crystalline thermoplastic resin as a main component (for example, equal to or more than 80% of crystalline thermoplastic resin are contained based on the entire composition rate.)

The crystalline thermoplastic resin will be described.

Although, the crystalline melt finish temperature of the crystalline thermoplastic resin measured by a differential scanning calorimeter depends on kinds of the resins, the range from 190° C. to 380° C. is preferable.

Although, the crystalline melt start temperature of the crystalline thermoplastic resin measured by the differential scanning calorimeter depends on kinds of the resins, the range from 160° C. to 350° C. is preferable.

Although, the difference (crystalline melt finish temperature-crystalline melt start temperature) between the crystalline melt finish temperature and the crystalline melt start temperature of the crystalline thermoplastic resin measured by the differential scanning calorimeter depends on kinds of the resins, the range not more than 80° C. is preferable.

Although the heating temperature (which is the temperature to melt the resin in the barrel 32: a heating condition) when extrusion molding of the resin composition which contains the crystalline thermoplastic resin having the above-mentioned melting characteristics is performed is determined by the melt point based on the DSC curve obtained from the differential scanning calorimeter and the melt viscosity of the resins at the melt point thereof, for example, the range from 160° C. to 400° C. (preferably, from 200° C. to 350° C.) may be exemplified.

In this case, the crystalline thermoplastic resin is what is plasticized through rising of a temperature and shows the specific peak of endothermic heat instead of showing the step-shaped variation of endothermic heat absorption in the DSC curve which is obtained from the differential scanning calorimeter.

Specifically, for example, the crystalline thermoplastic resin means that the half width of the endothermic heat peak which is measured with the rate of temperature rise of 10° C./min is within 10° C.

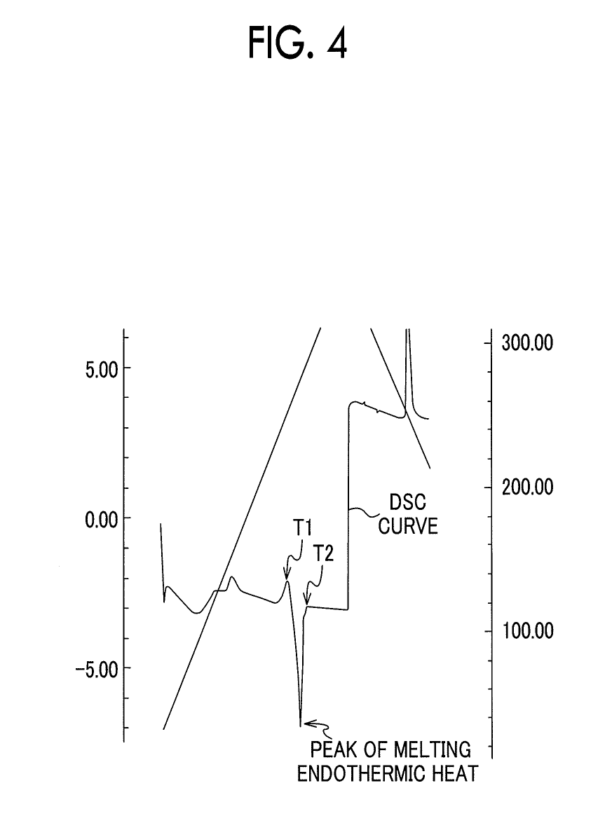

Moreover, the crystalline melt finish temperature and the crystalline melt start temperature by the differential scanning calorimeter are obtained from the DSC curve (see FIG. 4) which is measured from the differential scanning calorimeter (DSC). In the DSC curve of FIG. 4 shown as an example, the crystalline melt start temperature is the decreasing peak temperature of the melting endothermic heat indicated as T1 and the crystalline melt finish temperature is the rising peak temperature of the melting endothermic heat indicated as T2.

Measuring method (conditions) of DSC curves of the differential scanning calorimeter (DSC) is as follows. The evaluation of the crystalline melt start temperature and the crystalline melt finish temperature is implemented by the following measuring device and measurement conditions.

Device: differential scanning calorimeter DSC-60, manufactured by Shimadzu Corporation.

Heating rate: 10° C./min

Cooling rate: −10° C./min

Sample amount: from 10 mg to 16 mg

Atmosphere gas: nitrogen

Specifically, for example, a semi-aromatic polyamide resin which is derived from an aromatic dicarboxylic acid compound and an aliphatic diamine compound of which the carbon number is from 9 to 13 and has at least a repeat unit structure is included as the representative material of the crystalline thermoplastic resin.

In the electrophotographic image forming apparatus adopting the tubular body which contains a semi-aromatic polyamide resin as an intermediate transfer belt thereof, the compressive elasticity modulus of a surface of the intermediate transfer belt is relatively high, whereby a satisfactory cleaning performance and maintainability thereof are attained. Also, a satisfactorily long lifespan may be achieved as well with respect to a crack growth resistance of which a representative example is repeated-bending fatigue.

Furthermore, although, among amorphous thermoplastic resins, there are resins having the mechanical strength comparable to that of crystalline thermoplastic resin (which is a semi-aromatic polyamide resin), such as a tensile modulus, the resistance thereof against the repeated-bending fatigue is not enough. In a case where adopting the tubular body which contains an amorphous thermoplastic resin as an intermediate transfer belt which may be in an intensely bended state, it is required that a reinforcement layer should be provided in the end portion of the tubular body in order to improve the resistance thereof against the bending fatigue. Thereby, it is disadvantageous in terms of cost due to the manufacturing of the reinforcement layer itself and the increased processes of adhesive processing.

A semi-aromatic polyamide resin will be described.

A semi-aromatic polyamide resin is the semi-aromatic polyamide resin which is derived from an aromatic dicarboxylic acid compound and an aliphatic diamine compound of which the number of alkyl groups is from 9 to 12 and has at least a repeat unit structure.

Specifically, for example, a condensation polymerized product of an aromatic dicarboxylic acid compound and an aliphatic diamine compound is included as a semi-aromatic polyamide resin.

An aromatic dicarboxylic acid compound is the dicarboxylic acid compound having an aromatic ring (which is, for example, a benzene ring, a naphthalene ring, a biphenyl ring, or the like).

Specifically, for example, terephthalic acid, isophthalic acid, 2,6-naphthalene dicarboxylic acid, 2,7-naphthalene dicarboxylic acid, 1,4-naphthalene dicarboxylic acid, 1,4-phenylenedioxydiacetic acid, 1,3-phenylenedioxydiacetic acid, dibenzoic acid, 4,4′-oxydibenzoic acid, diphenylmethane-4,4-dicarboxylic acid, diphenyl sulfone-4,4-dicarboxylic acid, 4,4′-biphenylcarboxylic acid or the like are included as the aromatic dicarboxylic acid compound.

Among the above-mentioned materials, for example, terephthalic acid, isophthalic acid, 2,6-naphthalene dicarboxylic acid are preferable, and terephthalic acid is more preferable from the view point of the profitability and the performance of a polyamide.

An aliphatic diamine compound is the aliphatic diamine compound of which the number of the alkyl group (that is, the carbon number) is from 9 to 13 (preferably, from 9 to 12 and more preferably, from 10 to 11).

In this case, in the aliphatic diamine compound, the number of the alkyl group of the aliphatic diamine compound means the carbon number of the aliphatic group (which is the alkyl group) in which two amino groups are connected.

From the view point of the cleaning performance of a tubular body, it is considered that the concentration of the amino group of the semi-aromatic polyamide resin is high when the number of the alkyl group of the aliphatic diamine compound is less than 9, whereby the compressive elastic modulus thereof is deteriorated by moisture absorption. Therefore, there is a tendency that the cleaning performance of the tubular body is deteriorated.

Meanwhile, it is also considered that the concentration of the aromatic ring of the semi-aromatic polyamide resin is deteriorated when the number of the alkyl group is more than 13, whereby the compressive elastic modulus is deteriorated. Thereby, the rigidity and surface hardness may be deteriorated. Therefore, there is a tendency that the cleaning performance of the tubular body is deteriorated.

As a result, the deterioration of the cleaning performance of the tubular body is suppressed when the number of the alkyl group of the aliphatic diamine compound is in the range from 9 to 13.

In addition, from the view point of the electrical resistance of a tubular body, it is considered that, when the number of the alkyl group of the aliphatic diamine compound is less than 9, a carbon black is eliminated from the semi-aromatic polyamide resin through crystallization which is caused by cooling of the semi-aromatic polyamide resin after melting thereof, whereby the carbon black forms aggregates. As a result, a conductive path may be formed so as to deteriorate the electrical resistance.

Meanwhile, the concentration of the aromatic ring of the semi-aromatic polyamide resin is deteriorated when the number of the alkyl group is more than 12 and thus a cohesive force between the molecules of the semi-aromatic polyamide resin is deteriorated, whereby the dispersed state of the carbon blacks may be impaired.

As a result, when the number of the alkyl group of the aliphatic diamine compound is within the above range, the maintainability of the electrical resistance of the tubular body is improved.

Specifically, for example, a straight-chain aliphatic alkylenediamine (for example, 1,9-nonanediamine, 1,10-decane diamine, 1,11-undecane diamine, 1,12-dodecane diamine, or the like), a branched chain aliphatic alkylenediamine (for example, 2,2,4-trimethyl-1,6-hexanediamine, 2,4,4-trimethyl-1,6-hexanediamine, 2,4-diethyl-1,6-hexanediamine, 2,2-dimethyl-1,7-heptane diamine, 2,3-dimethyl-1,7-heptane diamine, 2,4-dimethyl-1,7-heptane diamine, 2,5-dimethyl-1,7-heptane diamine, 2-methyl-1,8-octane diamine, 3-methyl-1,8-octane diamine, 4-methyl-1,8-octane diamine, 1,3-dimethyl-1,8-octane diamine, 1,4-dimethyl-1,8-octane diamine, 2,4-dimethyl-1,8-octane diamine, 3,4-dimethyl-1,8-octane diamine, 4,5-dimethyl-1,8-octane diamine, 2,2-dimethyl-1,8-octane diamine, 3,3-dimethyl-1,8-octane diamine, 4,4-dimethyl-1,8-octane diamine, 5-methyl-1,9-nonanediamine, or the like), a cyclic aliphatic alkylenediamine (for example, 1-amino-3-aminomethyl-3,5,5-trimethylcyclohexane, 1-amino-3-aminomethyl-2,5,6-trimethylcyclohexane, or the like) are included as an aliphatic diamine compound.

Among the above-mentioned materials, 1,10-decane diamine (decamethylene diamine) and 1,11-undecane diamine are preferable, and 1,10-decane diamine (decamethylene diamine) is more preferable from the view point of the performance of polyamide or the environmental protection, or the like.

Although a condensation polymerized product of an aromatic dicarboxylic acid compound and an aliphatic diamine compound is included as a semi-aromatic polyamide resin, a polymerization product of the condensation polymerized product and other monomer (for example, a polyamide-polyether block copolymer, or the like) could be included unless the function thereof is impaired.

In this case, in the polyamide-polyether block copolymer, for example, a polyalkylene glycol of which the carbon number of the alkylene is from 2 to 6 (preferably, from 2 to 4) is included as a polyether which forms a polyether chain. Furthermore, for example, polytetramethyleneglycol (poly tetramethylene ether glycol), polyethylene glycol, polypropylene glycol and the copolymer thereof (for example, a polyethylene oxide-polypropylene oxide block copolymer) are specifically included.

Other additives will be described.

A conductive agent is included as other additives. As a representative material, a carbon black is included as the conductive agent. For example, an oil furnace black, a channel black, an acetylene black, or the like is included as the carbon black.

For example, well-known additives, such as an antioxidizing agent to prevent thermal degradation of the tubular body or a surfactant to improve liquidity, are also included as other additives.

Furthermore, for example, the tubular body which is obtained by the tubular body manufacturing method according to the exemplary embodiment may be adopted as a belt (for example, an intermediate transfer belt or a recording medium conveying transfer belt) of an image forming apparatus.

### EXAMPLES

Hereinafter, although the invention will be described in detail by way of examples, it should not be interpreted as being limited thereto.

In addition, “phr” indicates parts by weight based on 100 parts by weight of resin.

### Example 1

The resin pellets are made through melt-kneading 20 parts of a carbon black (Cabot Corporation: M880) as a conductive agent based on 100 parts of the polyamide10T (manufactured by Daicel-Evonik Ltd.: Vestamid F2001: a condensation product of the terephthalic acid which is the aromatic dicarboxylic acid compound and the 1,10-decane diamine which is the aliphatic diamine compound: the aromatic ring contained in the aromatic dicarboxylic acid compound is a benzene ring, and the number of the alkyl group in an aliphatic diamine compound is 10) as a crystalline thermoplastic resin by using the double-axial melt kneader (HK-25D, manufactured by Parker corporation, Inc.), under the condition in which the main barrel temperature and the motor torque are 280° C. and from 150 N·m to 170 N·m respectively.

Next, the full-flight type screw (1) of which the diameter D, the length of compressing portion Lc and the value of Lc/D are 40 mm, 200 mm and 5 respectively is inserted into a barrel of the single-axial extrusion molding machine (40V24D-HB, manufactured by MITSUBA MFG. CO., LTD). Then, a cross head die is mounted as an extrusion die so as to perform extrusion molding of a tubular body at 280° C. of the main barrel temperature. After that, the tubular body is cut after cooling, in which the diameter φ, the film thickness and the length of the tubular body are 160 mm, 100 μm and 250 mm respectively.

In addition, during extrusion molding, the motor torque is set in the range from 60% to 70% of the rated capacity, and the applied pressure of a resin is set in the range from 8 MPa to 14 MPa. In this case, abnormal phenomenon of torque is not generated during extrusion molding.

### Example 2

The resin pellets is made through melt-kneading 28 parts of a carbon black (Cabot Corporation: M880) as a conductive agent based on 100 parts of the polyamide12 (manufactured by UBE INDUSTRIES, LTD: Ubestar 3030 XU: the number of the alkyl group in an aliphatic diamine compound is 12) as a crystalline thermoplastic resin by using the double-axial melt kneader (HK-25D, manufactured by Parker corporation, Inc.), under the condition in which the main barrel temperature and the motor torque are 230° C. and from 150 N·m to 170 N·m respectively.

Next, the full-flight type screw (2) of which the diameter D, the length of compressing portion Lc and the value of Lc/D are 40 mm, 80 mm and 2 respectively is inserted into the barrel of the single-axial extrusion molding machine (40V24D-HB, manufactured by MITSUBA MFG. CO., LTD). Then, a cross head die is mounted as an extrusion die so as to perform extrusion molding of a tubular body at 230° C. of the main barrel temperature. After that, the tubular body is cut after cooling, in which the diameter φ, the film thickness and the length of the tubular body are 160 mm, 100 μm and 250 mm respectively.

In addition, during extrusion molding, the motor torque is set in the range from 55% to 70% of the rated capacity, and the applied pressure of a resin is set in the range from 6 MPa to 12 MPa. In this case, abnormal phenomenon of torque is not generated during extrusion molding.

### Example 3

The resin pellets is made through melt-kneading 21 parts of a carbon black (Cabot Corporation: M880) as a conductive agent based on 100 parts of the polyamide9T (manufactured by KURAUAY CO., LTD.: Genestar N1000D: a condensation product of the terephthalic acid which is the aromatic dicarboxylic acid and the 1,9-nonanediamine/2-methyl-1,8-octane diamine which is the aliphatic diamine compound: the aromatic ring contained in the aromatic dicarboxylic acid compound is a benzene ring, and the number of the alkyl group in the aliphatic diamine compound is 9) as a crystalline thermoplastic resin by using the double-axial melt kneader (HK-25D (41D), manufactured by Parker corporation, Inc.), under the condition in which the main barrel temperature and the motor torque are 290° C. and from 150 N·m to 170 N·m respectively.

Next, the full-flight type screw (2) of which the diameter D, the length of compressing portion Lc and the value of Lc/D are 40 mm, 80 mm and 2 respectively is inserted into the barrel of the single-axial extrusion molding machine (40V24D-HB, manufactured by MITSUBA MFG. CO., LTD). Then, a cross head die is mounted as an extrusion die so as to perform extrusion molding of a tubular body at 290° C. of the main barrel temperature. After that, the tubular body is cut after cooling, in which the diameter the film thickness and the length of the tubular body are 160 mm, 100 μm and 250 mm respectively.

In addition, during extrusion molding, the motor torque is set in the range from 60% to 70% of the rated capacity, and the applied pressure of a resin is set in the range from 7 MPa to 15 MPa. In this case, abnormal phenomenon of torque is not generated during extrusion molding.

### Example 4

Extrusion molding of a tubular body is performed in the same manner as Example 1 except for using the full-flight type screw (2) of which the diameter D, the length of compressing portion Lc and the value of Lc/D are 40 mm, 240 mm and 6 respectively. After that, the tubular body is cut after cooling, in which the diameter φ, the film thickness and the length of the tubular body are 160 mm, 100 μm and 250 mm respectively.

In addition, during extrusion molding, the motor torque is set in the range from 55% to 70% of the rated capacity, and the applied pressure of a resin is set in the range from 8 MPa to 15 MPa. In this case, abnormal phenomenon of torque is not generated during extrusion molding.

### Comparative Example 1

Extrusion molding of a tubular body is performed in the same manner as Example 1 except that the full-flight type screw (2) of which the diameter D, the length of compressing portion Lc and the value of Lc/D are 40 mm, 80 mm and 2 respectively is inserted into the barrel of the single-axial extrusion molding machine (40V24D-HB, manufactured by MITSUBA MFG. CO., LTD). In this case, the motor torque exceeds the upper limit, whereby a tubular body could not be obtained.

### Comparative Example 2

Extrusion molding of a tubular body is performed in the same manner as Example 2 except that the full-flight type screw (1) of which the diameter D, the length of compressing portion Lc and the value of Lc/D are 40 mm, 200 mm and 5 respectively is inserted into the barrel of the single-axial extrusion molding machine (40V24D-HB, manufactured by MITSUBA MFG. CO., LTD). In this case, the motor torque becomes in the range from 10% to 70% of the rated capacity, and the applied pressure of a resin becomes in the range from 0 MPa to 11 MPa. Also, the discharge rate becomes unstable. Thereby, the tubular body having unevenness of the film thickness is only obtained.

### Comparative Example 3

Extrusion molding of a tubular body is performed in the same manner as Example 3 except that the full-flight type screw (1) of which the diameter D, the length of compressing portion Lc and the value of Lc/D are 40 mm, 200 mm and 5 respectively is inserted into the barrel of the single-axial extrusion molding machine (40V24D-HB, manufactured by MITSUBA MFG. CO., LTD). In this case, the motor torque becomes in the range from 15% to 70% of the rated capacity and the applied pressure of a resin becomes in the range from 0 MPa to 25 MPa. Also, the discharge rate becomes unstable. Thereby, the tubular body having unevenness of the film thickness is only obtained.

### Comparative Example 4

Extrusion molding of a tubular body is performed in the same manner as Example 3 except that the full-flight type screw (1) of which the diameter D, the length of compressing portion Lc and the value of Lc/D are 40 mm, 240 mm and 6 respectively is inserted into the barrel of the single-axial extrusion molding machine (40V24D-HB, manufactured by MITSUBA MFG. CO., LTD). In this case, the motor torque becomes in the range from 20% to 70% of the rated capacity, and the applied pressure of a resin becomes in the range from 2 MPa to 20 MPa. Also, the discharge rate becomes unstable. Thereby, the tubular body having unevenness of the film thickness is only obtained.

(Evaluation)

—Film Thickness—

The film thickness of the tubular body obtained in each case is measured.

The film thickness of each tubular body is measured at three points in the axial direction and eight points in the circumferential direction using a micrometer. Then the average value (the average film thickness) and the difference between the maximum value and the minimum value of the film thickness are examined. The difference between the maximum value and the minimum value of the film thickness is set as unevenness of the film thickness.

—Electrical Resistance Characteristic—

The surface resistivity of the tubular body obtained in each case is evaluated. The surface resistivity is measured under the room temperature and normal humidity (the temperature is 22° C. and the humidity is 55 RH %) when 100 V voltage is applied.

—Color Deviation Characteristic—

The tubular body obtained in each case is mounted on the image forming apparatus, C2250 manufactured by Fuji Xerox Co., Ltd., as an intermediate transfer belt. Next, 100 images are continuously printed under the low temperature and low humidity condition (that is, under the condition in which electrical discharge easily occurs due to paper peeling on the surface of the intermediate transfer belt during a transfer process), in which the temperature and humidity are 10° C. and 10% RH respectively, and then the evaluation of color deviation is carried out.

In this case, the criteria of the evaluation of color deviation are as follows.

A: No color deviation.

B: Slight amounts of color deviation are found, but acceptable level.

C: Large amounts of color deviation are found (Not acceptable level).

—Environmental Dependency—

The surface resistivity of the tubular body obtained in each case is measured. In this case the surface resistivity is measured in the two conditions of which one is under the low temperature and low humidity (the temperature is 10° C. and the humidity is 10 RH %) when 100 V voltage is applied and the other is under the high temperature and high humidity (the temperature is 30° C. and the humidity is 85 RH %) when 100 V voltage is applied. Then the difference therebetween is evaluated as an environmental dependency.

—Voltage Dependency—

The surface resistivity of the tubular body obtained in each case is measured. In this case the surface resistivity is measured in the two conditions of which one is under the room temperature and normal humidity (the temperature is 22° C. and the humidity is 55 RH %) when 100 V voltage is applied and the other is under the room temperature and normal humidity (the temperature is 22° C. and the humidity is 55 RH %) when 1000 V voltage is applied. Then the difference therebetween is evaluated as a voltage dependency.

—Evaluation of Compressive Elastic Modulus—

On the tubular body obtained in each case, the compressive elastic modulus E1 which is under the condition of the normal humidity, the compressive elastic modulus E2 which is under the condition of the saturated moisture absorption and the difference thereof (E1−E2) are examined.

—Cleaning Maintainability—

The tubular body obtained in each case is mounted on the image forming apparatus, which is DocuPrint C2250 trademarked and manufactured by Fuji Xerox Co., Ltd., as an intermediate transfer belt. Next, 50,000 images are continuously printed under the high temperature and high humidity condition, in which the temperature and humidity are 28° C. and 85% RH respectively, and then the cleaning maintainability of the halftone images (magenta 30%) is confirmed.

In this case, the generation of cleaning failure is evaluated by the following criteria.

A: No white spot generation due to cleaning failure.

B: Slight amounts of white spot generation due to cleaning failure (Acceptable level).

C: Noticeable white spot are generated due to cleaning failure (Not acceptable level).

The details of each case and the results of aforementioned evaluations are shown in the list in Table 1 and Table 2.

TABLE 1

| | | Example 1 | Example 2 | Example 3 | Example 4 |
|---|---|---|---|---|---|
| | Sort | PA10T | PA12 | PA9T | PA10T |
| Crystalline | Crystalline melt start temperature | 218 | 160 | 250 | 218 |
| thermoplastic | T1 (° C.) | | | | |
| resin | | | | | |
| | Crystalline melt finish | 278 | 191 | 290 | 278 |
| | temperature T2 (° C.) | | | | |
| | ΔT = T2 − T1 (° C.) | 60 | 31 | 40 | 60 |
| Screw | Sort | (1) | (2) | (2) | (3) |
| | Total length {Ls + Lc + Lm} (mm) | 960 | 960 | 960 | 960 |
| | Diameter D (mm) | 40 | 40 | 40 | 40 |
| | Length of compressing portion Lc | 200 | 80 | 80 | 240 |
| | (mm) | | | | |
| | Length of supply portion Ls (mm) | 480 | 640 | 640 | 400 |
| | Diameter of shaft member of | 24 | 28 | 28 | 22 |
| | supply portion Ds (mm) | | | | |
| | Height of protrusion of supply | 8 | 7 | 7 | 9 |
| | portion Ts (mm) | | | | |
| | Length of measuring portion Lm | 280 | 240 | 240 | 320 |
| | (mm) | | | | |
| | Diameter of shaft member of | 35 | 36 | 36 | 34.8 |
| | measuring portion Dm (mm) | | | | |
| | Height of protrusion of measuring | 3 | 1.7 | 1.7 | 2.6 |
| | portion Tm (mm) | | | | |
| Value of [(ΔTm/10) − 3]/Value of [Lc/D] /Value of | | 3/5/7 | 0.1/2/4.1 | 1/2/5 | 3/6/7 |
| [(Δ Tm/10) + 1] | | | | | |
| Establishment of Expression (1) | | Established | Established | Established | Established |
| Average film thickness (μm) | | 102 | 99 | 100 | 100 |
| Unevenness of film thickness (μm) | | 8 | 7 | 9 | 7 |
| Color deviation characteristic | | A | A | A | A |
| Electrical | Surface resistivity (log Ω/□) | 10.2 | 10.3 | 9.9 | 10.0 |
| characteristic | Environmental dependency of | 0.3 | 0.2 | 0.2 | 0.3 |
| | Surface resistivity (log Ω/□) | | | | |
| | Voltage dependency of surface | 0.2 | 0.3 | 0.3 | 0.3 |
| | resistivity (log Ω/□) | | | | |

| | | | | |
|---|---|---|---|---|
| Compressive elastic modulus (MPa) | 5200 | 2600 | 4900 | 5150 |
| Cleaning maintainability | A | B | A | A |

TABLE 2

| | | Comparative | Comparative | Comparative | Comparative |
|---|---|---|---|---|---|
| | | Example 1 | Example 2 | Example 3 | Example 4 |
| | Sort | PA10T | PA12 | PA9T | PA9T |
| Crystalline | Crystalline melt start temperature | 218 | 160 | 250 | 250 |
| thermoplastic | T1 (° C.) | | | | |
| resin | Crystalline melt finish | 278 | 191 | 290 | 290 |
| | temperature T2 (° C.) | | | | |
| | ΔT = T2 − T1 (° C.) | 60 | 31 | 40 | 40 |
| Screw | Sort | (2) | (1) | (1) | (3) |
| | Total length (mm) | 960 | 960 | 960 | 960 |
| | Diameter D (mm) | 40 | 40 | 40 | 40 |
| | Length of compressing portion Lc | 80 | 200 | 200 | 240 |
| | (mm) | | | | |
| | Length of supply portion Ls (mm) | 640 | 480 | 480 | 400 |
| | Diameter of shaft member of | 28 | 24 | 24 | 22 |
| | supply portion Ds (mm) | | | | |
| | Height of protrusion of supply | 7 | 8 | 8 | 9 |
| | portion Ts (mm) | | | | |
| | Length of measuring portion Lm | 240 | 280 | 280 | 320 |
| | (mm) | | | | |
| | Diameter of shaft member of | 36 | 35 | 35 | 34.8 |
| | measuring portion Dm (mm) | | | | |
| | Height of protrusion of measuring | 1.7 | 3 | 3 | 2.6 |
| | portion Tm (mm) | | | | |
| Value of [(ΔTm/10) − 3]/Value of [Lc/D] /Value of | | 3/2/7 | 0.1/5/4.1 | 1/5/5 | 1/6/5 |
| [(Δ Tm/10) + 1] | | | | | |
| Establishment of Expression (1) | | Not | Not | Not | Not |
| | | Established | Established | Established | Established |
| Average film thickness (μm) | | Molding | 96 | 101 | 105 |
| Unevenness of film thickness (μm) | | Failure | 17 | 21 | 18 |
| Color deviation characteristic | | | C | C | C |
| Electrical | Surface resistivity (log Ω/□) | | 9.5 | 9.7 | 9.8 |
| characteristic | Environmental dependency of | | 0.2 | 0.3 | 0.2 |
| | Surface resistivity (log Ω/□) | | | | |
| | Voltage dependency of surface | | 0.7 | 0.8 | 0.5 |
| | resistivity (log Ω/□) | | | | |

| | | | |
|---|---|---|---|
| Compressive elastic modulus (MPa) | 2600 | 4900 | 4700 |
| Cleaning maintainability | B | A | A |

According to the above results, it is known that the tubular body in which unevenness of the film thickness is suppressed is obtained in the examples of the invention, compared to the comparative examples.

Furthermore, a positive result is confirmed in the tubular body of the examples with respect to the evaluation of the color deviation characteristic, the electrical characteristic, the compressive elastic modulus, the cleaning maintainability or the like.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A method for manufacturing a tubular body, comprising:
preparing a resin composition containing a crystalline thermoplastic resin; and
molding the tubular body, using an extrusion molding machine including a cylindrical portion having a heat source and a transport member that is inserted into the inside of the cylindrical portion and has a shaft member and a protrusion that is provided in a helical-shape on an outer circumference surface of the shaft member and is divided into a supply portion, a compressing portion and a measuring portion, by melting, kneading and transporting the resin composition in the inside of the cylindrical portion from one end toward the other end thereof through heating of the heat source and rotation of the transport member, and then extruding the molten resin composition,
wherein, when ΔTm (° C.) is a difference between a crystalline melt finish temperature and a crystalline melt start temperature of the crystalline thermoplastic resin measured by a differential scanning calorimeter, D (mm) is a diameter of the transport member, and Lc (mm) is a length of the compressing portion of the transport member, a relationship represented by Expression (1) is satisfied:
(ΔTm/10)−3<Lc/D<(ΔTm/10)+1. Expression (1):

2. The method for manufacturing a tubular body according to claim 1, wherein a relationship represented by Expression (1-2) is satisfied:
(ΔTm/10)−2<Lc/D<(ΔTm/10). Expression (1-2):

3. The method for manufacturing a tubular body according to claim 1,
wherein the diameter of the transport member represented by D is within the range from 25 mm to 60 mm.

4. The method for manufacturing a tubular body according to claim 1,
wherein the diameter of the transport member represented by D is within the range from 30 mm to 50 mm.

5. The method for manufacturing a tubular body according to claim 1,
wherein the diameter of the transport member represented by D is within the range from 30 mm to 45 mm.

6. The method for manufacturing a tubular body according to claim 1,
wherein the length of the compressing portion of the transport member represented by Lc is within the range from 50 mm to 540 mm.

7. The method for manufacturing a tubular body according to claim 1,
wherein the length of the compressing portion of the transport member represented by Lc is within the range from 60 mm to 240 mm.

8. The method for manufacturing a tubular body according to claim 2,
wherein the diameter of the transport member represented by D is within the range from 25 mm to 60 mm.

9. The method for manufacturing a tubular body according to claim 2,
wherein the diameter of the transport member represented by D is within the range from 30 mm to 50 mm.

10. The method for manufacturing a tubular body according to claim 2,
wherein the diameter of the transport member represented by D is within the range from 30 mm to 45 mm.

11. The method for manufacturing a tubular body according to claim 2,
wherein the length of the compressing portion of the transport member represented by Lc is within the range from 50 mm to 540 mm.

12. The method for manufacturing a tubular body according to claim 2,
wherein the length of the compressing portion of the transport member represented by Lc is within the range from 60 mm to 240 mm.

13. The method for manufacturing a tubular body according to claim 1,
wherein the crystalline thermoplastic resin is a semi-aromatic polyamide resin that is derived from an aromatic dicarboxylic acid compound and an aliphatic diamine compound of which the number of alkyl groups is from 9 to 13 and has at least a repeat unit structure.

14. The method for manufacturing a tubular body according to claim 13,
wherein the aromatic dicarboxylic acid compound is selected from the group consisting of terephthalic acid, isophthalic acid, 2,6-naphthalene dicarboxylic acid, 2,7-naphthalene dicarboxylic acid, 1,4-naphthalene dicarboxylic acid, 1,4-phenylenedioxydiacetic acid, 1,3-phenylenedioxydiacetic acid, dibenzoic acid, 4,4′-oxydibenzoic acid, diphenylmethane-4,4-dicarboxylic acid, diphenyl sulfone-4,4-dicarboxylic acid, and 4,4′-biphenylcarboxylic acid.

15. The method for manufacturing a tubular body according to claim 13,
wherein the aliphatic diamine compound has the number of alkyl groups of from 9 to 12.

16. The method for manufacturing a tubular body according to claim 13,
wherein the aliphatic diamine compound has the number of alkyl groups of from 10 to 11.

17. The method for manufacturing a tubular body according to claim 1,
wherein the semi-aromatic polyamide resin is a condensation polymerized product of an aromatic dicarboxylic acid compound and an aliphatic diamine compound.
